(19) United States
(12) Patent Application Publication
(10) Pub. No.: US 2008/0144712 A1
(43) Pub. Date: Jun. 19, 2008

(54) Line merging video content

(76) Inventor: Rich Gasper, Phoenix, AZ (US)

Correspondence Address: TIPS GROUP, 1747 PENN. AVE. NW SUITE 300, WASHINGTON, DC, 20006-4604, US

(21) Appl. No.: 12/002,256

(22) Filed: Dec. 14, 2007

Related U.S. Application Data
(60) Provisional application No. 60/874,845, filed on Dec. 14, 2006.

(51) Int. Cl. H04B 1/66

(52) U.S. Cl. 375/240.01

(57) ABSTRACT

Reducing the file size for a video data file by obtaining the video data file in a data line format (4) that has multiple data lines which contain pixel information, organizing the data lines into groups, and merging the pixel information amongst the data lines in each of the groups to produce groups of merged single data lines (6). The merged single data lines are repetitive and are used to produce a reduced video data file. A video player plays the reduced video data file and updates (8) a data line by using the merged data line of each of the groups.

This application claims priority from U.S. provisional 60/874,845, filed Dec. 14, 2006, which is incorporated herein by reference.

### BACKGROUND

Unlike a frame by frame update in video content, such as used in a movie projector, many types of video content, such as television, use alternating line updates. For example, a standard television has 325 lines of resolution, but instead of being updated all at once like a movie projector, every other line is updated in a continuous process. In other words, every odd line is updated, and then every even line. This creates a flowing image for the viewer.

High definition (HD) video uses the same technique of updating the image, but the resolution is much higher with 720 lines, 1080 lines, either interlaced or progressive, or even more. As a result, the file sizes of HD video are enormous and are not easily transferred.

What is needed is a technique for reducing video file sizes while maintaining a high quality. Other difficulties with the prior art also exist, some of which will be apparent upon further reading.

### SUMMARY OF THE INVENTION

The present invention provides for a method of reducing file sizes for video by merging adjoining data lines into a merged data line that then represents the data of the original lines. Many lines may be merged at once, but particular embodiments merge only two adjoining lines. The merged lines may then be merged again for multiple generation of merged data lines. The present invention can be used on alternating or progressive line updating.

If lines are too disparate, then they can remain unmerged. This minimal threshold of similarity can be varied depending on a number of objective and subjective standards. Also, individual pixel fields can remain unmerged so that the remaining pixels in the data line can be merged under the minimal standards.

Video data that has a large number of data lines is benefited most by the present invention, since the slight loss of quality by a line merger will largely go unnoticed in high definition video.

Other embodiments of the present invention also exist, which will be apparent upon further reading of the detailed description.

### BRIEF DESCRIPTION OF THE FIGURES

FIG. 1 illustrates a stylized example of data line merging.

FIG. 2 illustrates merged data lines being updated in an alternating line fashion.

FIG. 3 illustrates individual pixels being left unmerged due to high disparity during a data line merger.

### DETAILED DESCRIPTION OF THE INVENTION

The present invention reduces the size of video files that use alternating line updating, and even progressive line updating, with little or no apparent reduction in video quality. Due to the large number of lines in the resolution of high definition (HD), the present invention is particularly suited to reducing the file size of HD video. This is not only because the file sizes of HD are quite large and in need of reduction, but also because the present invention maintains visual quality better in images that have a higher line resolution.

As discussed, some video content, such as television broadcast, update an image in an every other line fashion. In other words, every odd line is updated, then every even line, at a rate of about 30 times per second. Every other line (EOL) updating produces a completely fluid image for the viewer.

The present invention reduces file size by merging lines, and then performing the same EOL updating. Although any number of lines can be merged, in order to maintain the highest image quality, only two adjacent lines are merged. So, in a simplified example, a video that has four lines of resolution, will have lines one and two merged into a single data line, and similarly, lines three and four into another single data line. This single merged data line (SDL) is then put into the line one position (and the other single data line into the line three position) when the odd lines are being updated. Then, when the even lines are being updated, the same SDL is put into the line two position (and the other SDL into the line four position). New SDL lines are then determined and put into position in a similar manner.

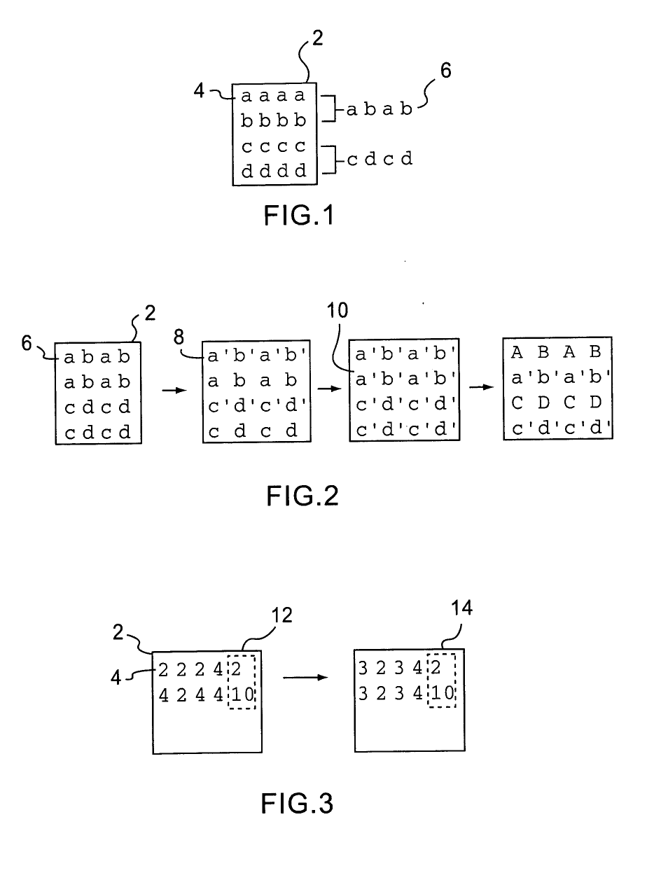

FIG. 1 illustrates a simplified image 2 that is made up of four data lines 4. Two pairing data lines are merged to produce two SDLs 6. The merging of the two data lines can be performed in a number of ways, for example, by simply dropping one of the data lines and duplicating another. However, one particular technique is to simply quantify (if not already sufficiently quantified) and average data in respective pixels along each line. For example, a given line could have hundreds of data pixels, each of which dictates a particular color at that point along the line. Averaging the particular color code between two pixels is relatively simple task that will be apparent to one of ordinary skill in the art. It is important to note that although the figure represents the merger as taking data in an every other pixel fashion, this simply represents merged lines, and is not how the lines are merged, just as data lines are not typically made up of one type of data field.

FIG. 2 illustrates a simplified example of how this EOL updating will work through four frames. The image 2 contains four lines of data (which could be merged data lines to begin with). First, the odd lines are updated 8, and then the even lines are updated 10. This process is then repeated for as long as the video runs. In the example given, the overall data of the entire video file can be reduced by about half. This is an example of alternating line updating, but the present invention will be equally applicable to progressive line updating as well. Progressive updating can update uniformly, (showing two merged lines at a time as shown in the first frame of FIG. 2), or the update can be staggered, (updating alternating merged lines, as shown in the second frame of FIG. 2). The programs used can also flip an alternating updating to a progressive updating and vice versa.

Of course, if three, four, or more lines are merged instead of two, then the file size will be reduced accordingly. Personal preference will come into play into this requirement, and video files can be reduced in these different ways depending on the target audiences. In addition, second generation mergers may be performed as discussed below.

In some cases, the lines may not be merged because they have a sum difference above a certain threshold. A sum difference is the difference in all the pixels a line has between its original content and the merged content. For example, if one line is all black, and another is all white, the difference between the two lines versus the merged line will be great. Exactly what the sum difference threshold is will depend on a number of subjective and objective parameters. For example, the greater the number of data lines in the image, the greater the sum difference threshold can be since the human eye will be less likely to notice the line merges in a more detailed image. Also, the larger the viewed image is, the smaller the sum difference threshold should be, since larger images (e.g. large screen TVs) will tend to reveal drastic mergers more.

Personal preference thresholds will also play a part in the amount of sum difference tolerated. Video files may even be offered at multiple levels of quality, since many users will opt for the larger file size if it means a higher quality.

A sum difference threshold can also be applied to second generation SDLs, whether or not the threshold was applied to the first generation. For example, two or more neighboring SDLs can themselves be merged to form a second generation single merged data line (2SDL). Third, fourth, fifth or more generation SDLs can be progressively performed on these SDLs. To maintain image quality, a sum difference threshold should in most cases be applied to the 2SDLs. The sum difference threshold on the 2SDLs can also be set at a higher threshold than the first generation SDLs (if used). In other words, the SDLs will only merge into second generation SDL if a high sum difference threshold is met. A third generation SDL may then have an ever higher sum difference threshold, and so on.

A second way of improving quality over a straight SDL is to maintain individual pixels. In other words, lines are merged, but particular disparate pixels are maintained in their original form. FIG. 3 illustrates an example of an image 2 composed of data lines 4, this time represented on a scale of 1 to 10. Two of the numbers 12 are much more disparate than the rest, so the two numbers are not merged 14 when the SDL is created. This can be performed for any number of pixels or groups of pixels in the data lines. This is a simplified example using a typical pixel scale is 0-65535, and even converged into an RBG, hue tint is from 0-255, but the principal remains the same.

The maintaining of individual pixels technique may also be combined with the sum difference threshold technique. For example, two lines that do not meet the sum difference threshold may have individual pixels maintained until the remaining pixels fit into the sum difference threshold.

Standard compression techniques can also be applied to the line merged video data.

As discussed, the present invention is particularly suited to HD video, and the greater the definition, the more the file sizes can be reduced with less perceptible loss of quality.

An example of the present invention written as annotated code follows:

### This Section of code manages the colorspace for video images By building colorspace tables original colors in a HD video is maintained.

### (IE the colorspace table are a kinda lookup table that is used for rapid lookup for reconstructing a pictures color depth)

```
int get_colorspace(BITMAPINFOHEADER * hdr)
{
  if (hdr->biHeight < 0)
  {
    DEBUGERR(“colorspace: inverted input format not supported”);
    return ALPH_CSP_NULL;
  }
  switch(hdr->biCompression)
  {
  case BI_RGB :
    if (hdr->biBitCount == 16)
    {
      DEBUG(“RGB16 (RGB555)”);
      return ALPH_CSP_VFLIP | ALPH_CSP_RGB555;
    }
    if (hdr->biBitCount == 24)
    {
      DEBUG(“RGB24”);
      return ALPH_CSP_VFLIP | ALPH_CSP_RGB24;
    }
    if (hdr->biBitCount == 32)
    {
      DEBUG(“RGB32”);
      return ALPH_CSP_VFLIP | ALPH_CSP_RGB32;
    }
    DEBUG1(“BI_RGB unsupported”, hdr->biBitCount);
    return ALPH_CSP_NULL;
// how do these work in BITMAPINFOHEADER ???
/* case BI_BITFIELDS :
    if (hdr->biBitCount == 16
    if(hdr->biBitCount = 16 &&
      hdr->bV4RedMask == 0x7c00 &&
      hdr->bV4GreenMask == 0x3e0 &&
      hdr->bV4BlueMask == 0x1f)
    {
      DEBUG(“RGB555”);
      return ALPH_CSP_VFLIP | ALPH_CSP_RGB555;
    }
    if(hdr->bV4BitCount == 16 &&
      hdr->bV4RedMask == 0xf800 &&
      hdr->bV4GreenMask == 0x7e0 &&
      hdr->bV4BlueMask == 0x1f)
    {
      DEBUG(“RGB565”);
      return ALPH_CSP_VFLIP | ALPH_CSP_RGB565;
    }
    DEBUG1(“BI_FIELDS unsupported”, hdr->bV4BitCount);
    return ALPH_CSP_NULL;
*/
  case FOURCC_I420:
  case FOURCC_IYUV:
    DEBUG(“IYUY”);
    return ALPH_CSP_I420;
  case FOURCC_YV12 :
    DEBUG(“YV12”);
    return ALPH_CSP_YV12;
  case FOURCC_YUYV :
  case FOURCC_YUY2 :
  case FOURCC_V422 :
    DEBUG(“YUY2”);
    return ALPH_CSP_YUY2;
  case FOURCC_YVYU:
    DEBUG(“YVYU”);
    return ALPH_CSP_YVYU;
  case FOURCC_UYVY:
    DEBUG(“UYVY”);
    return ALPH_CSP_UYVY;
  }
  DEBUGFOURCC(“colorspace: unknown”, hdr->biCompression);
  return ALPH_CSP_NULL;
}
```

### This Section of code manages the quality of the video image compression ratio's By using a quality threshold, a failover threshold is maintained.

### (IE the higher the quality/threshold the more original data structure is maintained thru encoding reconstruction data)

```
int codec_get_vbr_quant(CONFIG* config, int quality)
{
  static float fquant_running = 0;
  static int my_quality = −1;
  int quant;
  // if quality changes, recalculate fquant (credits)
  if (quality != my_quality)
  {
    config->fquant = 0;
  }
  my_quality = quality;
  // desired quantiser = (maxQ−minQ)/100 * (100−qual) + minQ
  if (!config->fquant)
  {
    config->fquant =
      ((float) (config->max_pquant − config->min_pquant) / 100) *
      (100 − quality) +
      (float) config->min_pquant;
    fquant_running = config->fquant;
  }
  if (fquant_running < config->min_pquant)
  {
    fquant_running = (float) config->min_pquant;
  }
  else if(fquant_running > config->max_pquant)
  {
    fquant_running = (float) config->max_pquant;
  }
  quant = (int) fquant_running;
  // add error between fquant and quant to fquant_running
  fquant_running += config->fquant − quant;
  return quant;
}
```

### This Section of code is the main compression routine.

### It handle interopolation/intraopolation (The Even/Odd frame management)

### Also Luminance and Hue are handled by this area of code

### Keyframe management is also managed here (The glue to keep Audio & Video Synced)

### Basic Windows error management and calls to/from the WMI (Windows Media Interface) are handled here as well

### 2 Pass management (If chosen to be used) is overseen here as well.

```
LRESULT compress(CODEC * codec, ICCOMPRESS * icc)
{
    BITMAPINFOHEADER * inhdr = icc->lpbiInput;
    BITMAPINFOHEADER * outhdr = icc->lpbiOutput;
    ALPH_ENC_FRAME frame;
    ALPH_ENC_STATS stats;
    // mpeg2avi yuv bug workaround (2 instances of CODEC)
    if (codec->twopass.stats1 == INVALID_HANDLE_VALUE)
    {
        if (codec_2pass_init(codec) == ICERR_ERROR)
        {
            return ICERR_ERROR;
        }
    }
    frame.general = 0;
    frame.motion = 0;
    frame.intra = −1;
    frame.general |= ALPH_HALFPEL;
    if(codec->config.motion_search > 4)
        frame.general |= ALPH_INTER4V;
    if(((codec->config.mode == DLG_MODE_2PASS_1) ? 0 : codec-
>config.lum_masking) == 1)
        frame.general |= ALPH_LUMIMASKING;
    if (codec->config.interlacing)
        frame.general |= ALPH_INTERLACING;
    if (codec->config.hinted_me && codec->config.mode ==
DLG_MODE_2PASS_1)
    {
        frame.hint.hintstream = codec->twopass.hintstream;
        frame.hint.rawhints = 0;
        frame.general |= ALPH_HINTEDME_GET;
    }
    else if (codec->config.hinted_me && (codec->config.mode ==
DLG_MODE_2PASS_2_EXT || codec->config.mode == DLG_MODE_2PASS_2_INT))
    {
        DWORD read;
        DWORD blocksize;
        frame.hint.hintstream = codec->twopass.hintstream;
        frame.hint.rawhints = 0;
        frame.general |= ALPH_HINTEDME_SET;
        if (codec->twopass.hints == INVALID_HANDLE_VALUE)
        {
            codec->twopass.hints = CreateFile(codec->config.hintfile,
GENERIC_READ, 0, 0, OPEN_EXISTING, 0, 0);
            if (codec->twopass.hints == INVALID_HANDLE_VALUE)
            {
                DEBUGERR(“couldn't open hints file”);
                return ICERR_ERROR;
            }
        }
        if (!ReadFile(codec->twopass.hints, &blocksize, sizeof(DWORD), &read,
0) || read != sizeof(DWORD) ||
            !ReadFile(codec->twopass.hints, frame.hint.hintstream, blocksize,
&read, 0) || read != blocksize)
        {
            DEBUGERR(“couldn't read from hints file”);
            return ICERR_ERROR;
        }
    }
    frame.motion = pmvfast_presets[codec->config.motion_search];
    frame.image = icc->lpInput;
    if ((frame.colorspace = get_colorspace(inhdr)) == ALPH_CSP_NULL)
        return ICERR_BADFORMAT;
    frame.bitstream = icc->lpOutput;
    frame.length = icc->lpbiOutput->biSizeImage;
    switch (codec->config.mode)
    {
    case DLG_MODE_CBR :
        frame.quant = 0;
        break;
    case DLG_MODE_VBR_QUAL :
    case DLG_MODE_VBR_QUANT :
    case DLG_MODE_2PASS_1 :
        if (codec_get_quant(codec, &frame) == ICERR_ERROR)
        {
            return ICERR_ERROR;
        }
        break;
    case DLG_MODE_2PASS_2_EXT :
    case DLG_MODE_2PASS_2_INT :
        if (codec_2pass_get_quant(codec, &frame) == ICERR_ERROR)
        {
            return ICERR_ERROR;
        }
        if (codec->config.dummy2pass)
        {
            outhdr->biSizeImage = codec->twopass.bytes2;
            *icc->lpdwFlags = (codec->twopass.nns1.quant &
NNSTATS_KEYFRAME) ? AVIIF_KEYFRAME : 0;
            return ICERR_OK;
        }
        break;
    case DLG_MODE_NULL :
        outhdr->biSizeImage = 0;
        *icc.>lpdwFlags = AVIIF_KEYFRAME;
        return ICERR_OK;
    default :
        DEBUGERR(“Invalid encoding mode”);
        return ICERR_ERROR;
    }
    if (codec->config.quant_type == QUANT_MODE_H263)
    {
        frame.general |= ALPH_H263QUANT;
    }
    else
    {
        frame.general |= ALPH_MPEGQUANT;
        // we actually need “default/custom” selectbox for both inter/intra
        // this will do for now
        if (codec->config.quant_type == QUANT_MODE_CUSTOM)
        {
            frame.general |= ALPH_CUSTOM_QMATRIX;
            frame.quant_intra_matrix = codec->config.qmatrix_intra;
            frame.quant_inter_matrix = codec->config.qmatrix_inter;
        }
        else
        {
            frame.quant_intra_matrix = NULL;
            frame.quant_inter_matrix = NULL;
        }
    }
    // force keyframe spacing in 2-pass 1st pass
    if (codec->config.motion_search == 0)
    {
        frame.intra = 1;
    }
    else if (codec->keyspacing < codec->config.min_key_interval && codec-
>framenum)
    {
        DEBUG(“current frame forced to p-frame”);
        frame.intra = 0;
    }
    switch (alph_encore(codec->ehandle, ALPH_ENC_ENCODE, &frame, &stats))
    {
    case ALPH_ERR_FAIL :
        return ICERR_ERROR;
    case ALPH_ERR_MEMORY :
        return ICERR_MEMORY;
    case ALPH_ERR_FORMAT :
        return ICERR_BADFORMAT;
    }
    if (frame.intra)
    {
        codec->keyspacing = 0;
        *icc->lpdwFlags = AVIIF_KEYFRAME;
    }
    else
    {
        *icc->lpdwFlags = 0;
    }
    outhdr->biSizeImage = frame.length;
    if (codec->config.mode == DLG_MODE_2PASS_1 && codec-
>config.discard1pass)
    {
        outhdr->biSizeImage = 0;
    }
    if (frame.general & ALPH_HINTEDME_GET)
    {
        DWORD wrote;
        DWORD blocksize = frame.hint.hintlength;
        if (codec->twopass.hints == INVALID_HANDLE_VALUE)
        {
            codec->twopass.hints = CreateFile(codec->config.hintfile,
GENERIC_WRITE, 0, 0, CREATE_ALWAYS, 0, 0);
            if (codec->twopass.hints == INVALID_HANDLE_VALUE)
            {
                DEBUGERR(“couldn't create hints file”);
                return ICERR_ERROR;
            }
        }
        if (!WriteFile(codec->twopass.hints, &frame.hint.hintlength, sizeof(int),
&wrote, 0) || wrote != sizeof(int) ||
            !WriteFile(codec->twopass.hints, frame.hint.hintstream, blocksize,
&wrote, 0) || wrote != blocksize)
        {
            DEBUGERR(“couldn't write to hints file”);
            return ICERR_ERROR;
        }
    }
```

The above can also be used with other compression techniques as will be apparent to one of ordinary skill in the art.

In one embodiment, the present invention provides for a method of reducing the file size for a video data file by obtaining the video data file in a data line format that comprises multiple data lines which contain pixel information, organizing the data lines into groups, and merging the pixel information amongst the data lines in each of the groups to produce groups of merged single data lines. The merged single data lines are repetitive and are used to produce a reduced video data file. A video player plays the reduced video data file and updates a data line by using the merged data line of each of the groups.

In one aspect, a line merging calculation calculates a minimal threshold, and if the data lines in a given group are disparate beyond the minimal threshold, then the data lines are not merged. In a more particular aspect, the line merging calculation is performed automatically. In yet another particular aspect, individual disparate pixel fields are removed from the line merging calculation to bring the rest of the lines within the minimal threshold, the disparate pixel fields maintain their original pixel information. In another aspect, a user can influence the line merging calculation by requiring greater or lesser levels of quality in the reduced video data file.

In another aspect, the merging of the pixel information is done by averaging the data of each pixel position in the data lines in each of the groups. In one aspect, the groups are pairs of data lines.

In yet another aspect, adjoining merged groups are merged into a second generation merger to produce a second generation merged data line. In a more particular aspect, a second generation merged data line threshold of similarity is met before adjoining groups are merged, and in another particular aspect, a third generation of merged data lines are produced.

In another embodiment, the present invention provides for a method of reducing the file size for a video data file by obtaining the video data file in a data line format that has multiple data lines which contain pixel information, organizing the data lines into groups, and comparing the pixel information within each of the groups to a predetermined minimum average threshold. If the comparison of pixel information within a particular group meets the predetermined minimum average threshold, then the pixel information is merged amongst the data lines in each group to produce merged single data lines, which are repetitive, and are used to produce a reduced video data file. The reduced video data file is played by a video player which updates a data line by using the merged data line of each of the groups.

In one aspect, if a particular group does not meet the predetermined minimum average threshold, then disparate pixel fields are removed from the comparison of pixel information, and the pixel information in a particular group is compared again. In another aspect, a second comparison at a higher minimal average threshold is performed on adjoining groups, and if the second comparison is within the higher minimal average threshold, then adjoining groups are merged into a second generation merged single data line.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the inventions which is to be given the full breadth of the claims appended and any and all equivalents thereof.

What is claimed is:

1. A method of reducing the file size for a video data file by:
obtaining said video data file in a data line format that is comprised of multiple data lines, and wherein said multiple data lines contain pixel information;
organizing said data lines into groups;
merging said pixel information amongst said data lines in each of said groups to produce groups of merged single data lines, and wherein said merged single data lines are repetitive and are used to produce a reduced video data file;
wherein a video player plays said reduced video data file and updates a data line by using the merged data line of each of said groups.

2. The method of reducing the file size for a video data file according to claim 1, wherein, if said data lines in a given group are disparate beyond a minimal threshold, then said data lines are not merged, whereby, a line merging calculation calculates said minimal threshold.

3. The method of reducing the file size for a video data file according to claim 2, wherein said line merging calculation is performed automatically.

4. The method of reducing the file size for a video data file according to claim 2, wherein a user can influence said line merging calculation by requiring greater or lesser levels of quality in said reduced video data file.

5. The method of reducing the file size for a video data file according to claim 2, wherein individual disparate pixel fields are removed from said line merging calculation to bring the rest of the lines within said minimal threshold, wherein the disparate pixel fields maintain their original pixel information.

6. The method of reducing the file size for a video data file according to claim 1, wherein the merging of said pixel information is done by averaging the data of each pixel position in said data lines in each of said groups.

7. The method of reducing the file size for a video data file according to claim 1, wherein said groups are pairs of data lines.

8. The method of reducing the file size for a video data file according to claim 1, wherein adjoining merged groups are merged into a second generation merger to produce a second generation merged data line.

9. The method of reducing the file size for a video data file according to claim 8, wherein a second generation merged data line threshold of similarity is met before adjoining groups are merged.

10. The method of reducing the file size for a video data file according to claim 8, wherein a third generation of merged data lines are produced.

11. A method of reducing the file size for a video data file by:
obtaining said video data file in a data line format that is comprised of multiple data lines, and wherein said multiple data lines contain pixel information;
organizing said data lines into groups;
comparing the pixel information within each of the groups to a predetermined minimum average threshold;
wherein if the comparison of pixel information within a particular group meets said predetermined minimum average threshold, then merging said pixel information amongst said data lines in each to produce said merged single data lines;
wherein said merged single data lines are repetitive and are used to produce a reduced video data file;
wherein a video player plays said reduced video data file and updates a data line by using the merged data line of each of said groups.

12. The method of reducing the file size for a video data file according to claim 11, wherein if a particular group does not meet said predetermined minimum average threshold, then disparate pixel fields are removed from said comparison of pixel information, and said pixel information in a particular group is compared again.

13. The method of reducing the file size for a video data file according to claim 11, wherein a second comparison at a higher minimal average threshold is performed on adjoining groups, and if said second comparison is within said higher minimal average threshold, then adjoining groups are merged into a second generation merged single data line.
